(19) United States
(12) Patent Application Publication
(10) Pub. No.: US 2025/0011043 A1
(43) Pub. Date: Jan. 9, 2025

(54) Theft protection bag

(71) Applicant: Nelson R. De La Nuez, Orlando, FL (US)

(72) Inventor: Nelson R. De La Nuez, Orlando, FL (US)

(21) Appl. No.: 18/887,469

(22) Filed: Sep. 17, 2024

Related U.S. Application Data
(63) Continuation-in-part of application No. 17/702,392, filed on Mar. 23, 2022.
Application No. 17/702,392 is a continuation-in-part of application No. 16/695,039, filed on Nov. 25, 2019, now Pat. No. 11,326,856.
Application No. 16/695,039 is a continuation-in-part of application No. 16/417,556, filed on May 20, 2019, now abandoned.

(51) Int. Cl. B65D 33/28; B60R 25/01; B65D 30/08

(52) U.S. Cl. CPC B65D 33/28; B60R 25/01; B65D 29/02; B65D 2211/00; B65D 2255/00

(57) ABSTRACT

A theft protector bag includes: a lock bag with a bag portion made from a cut-resistant material and a cable guide; and a cable lock assembly, including a lock body, a lock cable, and a key; such that the lock cable protrudes through the cable guide to attach the cable lock assembly to the lock bag; such that the lock body is positionable over a side mirror of a vehicle, with the side mirror inside an interior of the bag portion, such that the theft protector bag can be secured and locked in position on the side mirror, thereby preventing theft of a mirror portion of the side mirror. Additionally, the theft protector bag can be secured in position with the lock cable attached to a mounting structure with the lock bag closed and a personal object locked in the interior of the lock bag.

### CROSS-REFERENCE TO RELATED APPLICATIONS

This application is a continuation-in-part of U.S. Non-Provisional application Ser. No. 17/702,392, filed Mar. 23, 2022, which is a continuation-in-part of U.S. Non-Provisional application Ser. No. 16/695,039, filed Nov. 25, 2019, now patented as U.S. Pat. No. 11,326,856, issued May 10, 2022, which is a continuation-in-part of U.S. Non-Provisional application Ser. No. 16/417,556, filed May 20, 2019; all of which are hereby incorporated herein by reference in their entirety.

### FIELD OF THE INVENTION

The present invention relates generally to the field of theft protector devices, and more particularly to methods and systems for theft protector bags for securing a vehicle rear-view side mirror and personal items from theft.

### BACKGROUND OF THE INVENTION

Vehicle side mirrors have in recent years become increasingly complicated including new electronic features, such as auto-dimming and in-built heating. Consequently, replacement of vehicle side mirrors is becoming increasingly expensive.

Due to the emerging secondary market for replacement side mirrors, they have become a target for thieves, which are able to quickly remove the mirror mechanism. However, while this is becoming an increasing problem, vehicle owners have no effective options available in the marketplace for protecting their side mirrors against theft.

As such, considering the foregoing, it may be appreciated that there continues to be a need for novel and improved devices and methods for securing a vehicle rear-view side mirror and personal-carry items from theft.

### SUMMARY OF THE INVENTION

The foregoing needs are met, to a great extent, by the present invention, wherein in aspects of this invention, enhancements are provided to the existing model of devices and methods for securing a vehicle rear-view side mirror from theft.

In an aspect, a theft protector bag, can include:
a) a lock bag, which can be made from a cut-resistant material, wherein the lock bag can include:
   a bag portion, which can be put over a side mirror, of a vehicle; and
   a cable guide, which can be mounted to an outer periphery of the bag portion along an opening to the interior of the bag portion, such that the cable guide for example can be:
      a continuous tube; or
      a plurality of reinforced holes; and
b) a cable lock assembly, which can include:
   a lock body;
   a lock cable, which can be releasably lockable onto the lock body, such that the lock cable forms a closed loop with a loop opening, when the cable lock assembly is locked; and
   a key, which is configured to lock and unlock the lock body, to secure and release the lock cable;
wherein the lock cable protrudes through the cable guide, such that the cable lock assembly is attached to the lock bag;
such that the lock body can be positioned over a side mirror of a vehicle, with the side mirror inside an interior of the bag portion, when the theft protector bag is unlocked; and
such that the theft protector bag is secured in position on the side mirror, thereby preventing theft of the mirror portion of the side mirror, when the theft protector bag is locked onto the side mirror.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. In addition, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view of a side mirror protection system, including a theft protector bag before installation on a side mirror of a vehicle, according to an embodiment of the invention.

FIG. 2 is a perspective view of a theft protector bag, which is installed on a side mirror of a vehicle, according to an embodiment of the invention.

FIG. 3 is a perspective view of a theft protector bag in a locked configuration, according to an embodiment of the invention.

FIG. 4A is a top view of parts of a bag-shaped layer of a bag portion of a theft protector bag, prior to assembly, according to an embodiment of the invention.

FIG. 4B is a perspective view of a bag-shaped layer of a bag portion of a theft protector bag that is assembled from the parts shown in FIG. 4A, according to an embodiment of the invention.

FIG. 5A is a schematic cross-sectional view of a cut-resistant material, according to an embodiment of the invention.

FIG. 5B is a schematic cross-sectional view of a cut-resistant material, according to an embodiment of the invention.

FIG. 5C is a schematic cross-sectional view of a cut-resistant material, according to an embodiment of the invention.

FIG. 5D is a schematic cross-sectional view of a portion of a cut-resistant material with an intermediate layer configured as a wire mesh, taken along section line 5D-5D of FIG. 9B, according to an embodiment of the invention.

FIG. 5E is a schematic cross-sectional view of a portion of a cut-resistant material with an intermediate layer configured as a wire mesh, taken along section line 5E-5E of FIG. 9B, according to an embodiment of the invention.

FIG. 6A is a perspective view of a theft protector bag in an open configuration, according to an embodiment of the invention.

FIG. 6B is a perspective view of a theft protector bag in an open configuration with an object partially inserted, according to an embodiment of the invention.

FIG. 6C is a perspective view of a theft protector bag in a locked configuration with an object in an interior of the theft protector bag, according to an embodiment of the invention.

FIG. 6D is a perspective view of a theft protector bag in a locked configuration and attached to a mounting structure, with an object in an interior of the theft protector bag, according to an embodiment of the invention.

FIG. 7A is a top front perspective view of an interior wire mesh bag of a theft protector bag, according to an embodiment of the invention.

FIG. 7B is a bottom rear perspective view of an interior wire mesh bag of a theft protector bag, according to an embodiment of the invention.

FIG. 7C is a top view of an interior wire mesh bag of a theft protector bag, according to an embodiment of the invention.

FIG. 7D is a bottom view of an interior wire mesh bag of a theft protector bag, according to an embodiment of the invention.

FIG. 7E is a front view of an interior wire mesh bag of a theft protector bag, according to an embodiment of the invention.

FIG. 7F is a rear view of an interior wire mesh bag of a theft protector bag, according to an embodiment of the invention.

FIG. 7G is a left-side view of an interior wire mesh bag of a theft protector bag, according to an embodiment of the invention.

FIG. 7H is a right-side view of an interior wire mesh bag of a theft protector bag, according to an embodiment of the invention.

FIG. 8A is schematic side view of an interior wire mesh bag in a laterally expanded configuration, according to an embodiment of the invention.

FIG. 8B is a schematic side view of an interior wire mesh bag in a laterally compressed configuration, according to an embodiment of the invention.

FIG. 9A is a perspective view of a theft protector bag configured as a personal unisex bag in use by user, according to an embodiment of the invention.

FIG. 9B is a perspective side view of the theft protector bag configured as a personal unisex bag, showing a portion of an interior wire mesh of an intermediate layer, according to an embodiment of the invention.

### DETAILED DESCRIPTION

Before describing the invention in detail, it should be observed that the present invention resides primarily in a novel and non-obvious combination of elements and process steps. So as not to obscure the disclosure with details that will readily be apparent to those skilled in the art, certain conventional elements and steps have been presented with lesser detail, while the drawings and specification describe in greater detail other elements and steps pertinent to understanding the invention.

The following embodiments are not intended to define limits as to the structure or method of the invention, but only to provide exemplary constructions. The embodiments are permissive rather than mandatory and illustrative rather than exhaustive.

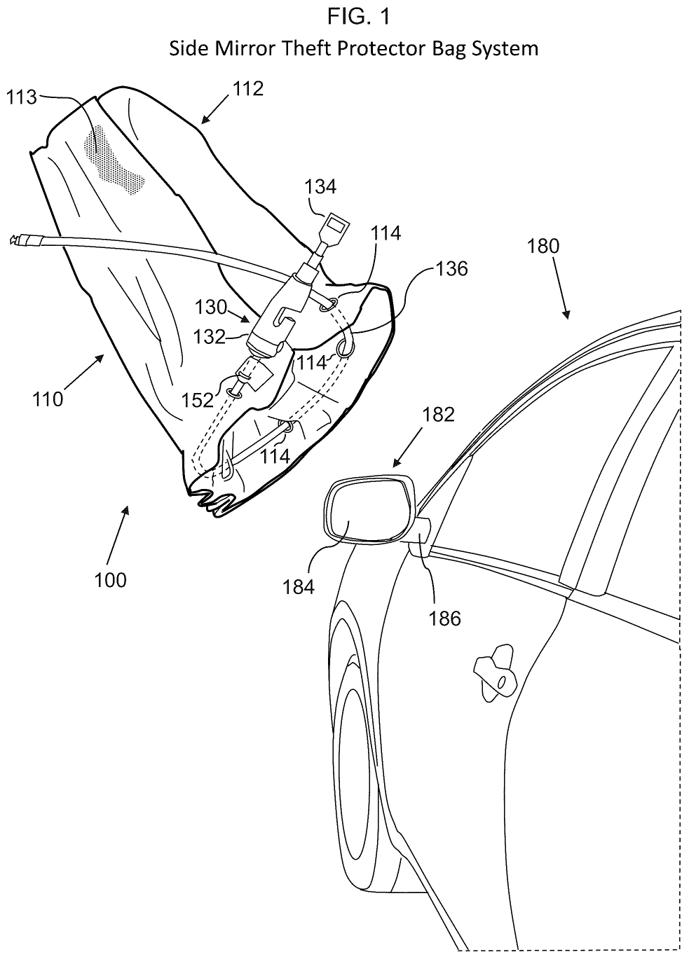

In the following, we describe the structure of an embodiment of a theft protector bag 100 with reference to FIG. 1, in such manner that like reference numerals refer to like components throughout; a convention that we shall employ for the remainder of this specification.

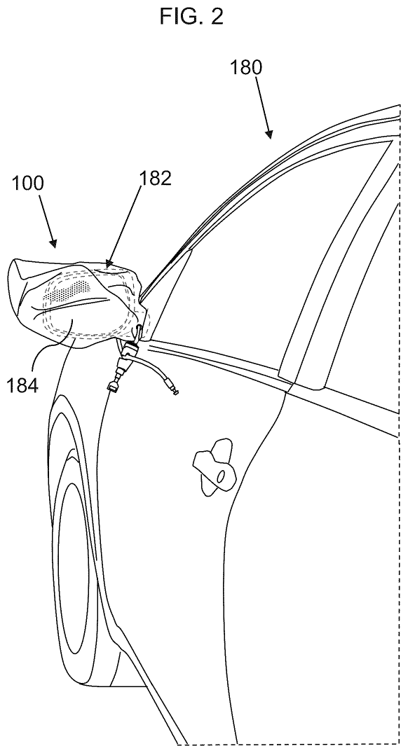

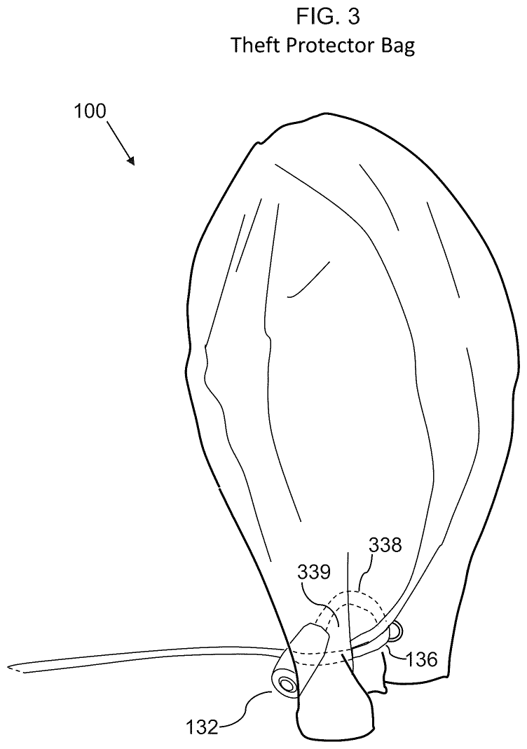

In an embodiment, as shown in FIG. 1, a theft protector bag 100, can include:
a) a lock bag 110, which can include:
   i. a bag portion 112, which can be made from a cut-resistant material 113, wherein the bag portion 112 can be configured such that it can be put over a side mirror 182 of a vehicle 180; and
   ii. a cable guide 114, which can be mounted to an outer periphery of the bag portion along an opening to the interior of the bag portion, such that the cable guide can be:
      1. a plurality of reinforced holes 114 in the cut-resistant material 113 or guide segments, which allows a lock cable 136 of a cable lock assembly 130 to be laced through the plurality of holes 114 or guide segments; or
      2. a continuous tube (also called a hem or casing; for example, formed by folding and sewing the outer ends of the material used for the bag portion); and
b) a cable lock assembly 130, which can include:
   i. a lock body 132, which for example can be locked and unlocked with a key 134 or other locking mechanism;
   ii. a lock cable 136, which can be releasably lockable onto the lock body 132, such that the cable lock assembly 130 and lock cable 136 forms a closed loop 338 with a loop opening 339, when the cable lock assembly 130 is locked, as shown in FIG. 3; and
   iii. a key 134, which is configured to lock and unlock the lock body 132, to secure and release the lock cable 136;
wherein the lock cable 136 protrudes through the cable guide, such that the cable lock assembly 130 is attached to the lock bag 110;
such that the lock body 132 can be positioned (i.e. is positionable) over a side mirror 182 of a vehicle 180, with the side mirror inside an interior of the bag portion, when the theft protector bag 100 is unlocked, such that a bag opening to an interior of the bag portion 112 is maximized, as shown in FIG. 1; and
such that the theft protector bag 100 is secured in position on the side mirror 182, such that the lock cable 136 is locked around a stem 186 of the side mirror 182 with the stem 186 protruding through the loop opening 339, such that the loop opening 339 is too small to allow removal of the theft protector bag 100, thereby preventing theft of the mirror portion 184 of the side mirror 182, when the theft protector bag 100 is locked onto the side mirror 182, as shown in FIG. 2. FIG. 3 shows the theft protector bag 100 in a locked configuration.

In related embodiments, the cut-resistant material 113, can be a metal mesh or chainmail material, a KEVLAR™ composite, a high performance poly ethylene material, a weave of STEELFIBER™ or fiberglass, and can for example include:
a) KEVLAR™ fabric, i.e. a fabric made from Poly-paraphenylene terephthalamide, including KEVLAR™ fabrics reinforced with carbon fiber;
b) CTU-TEX PRO™;
c) CUTLON 3130™;
d) HEXARMOR SUPERFABRIC™;
e) Ultra-high-molecular-weight polyethylene (UHMWPE);
f) A combination of UHMWPE, polyester and fiberglass;
g) A combination of these; and/or
h) Other anti-cut or cut-resistant fabric materials.

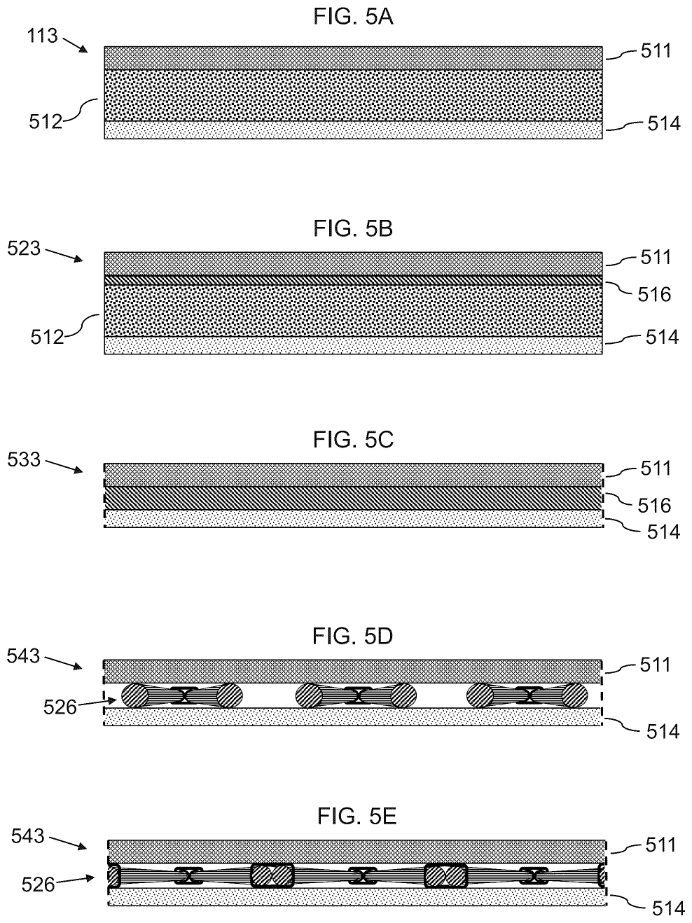

In a related embodiment, as shown in FIG. 5A, the cut-resistant material 113, can be configured as a composite multi-layer material, wherein the cut-resistant material 113 can include:
a) an outer cut-resistant layer 511, which can be made from a relatively hard material, which is both relatively strong and relatively hard, such as for example: a woven fabric made from UHMWPE (Ultra-High Molecular Weight Polyethylene), which can be configured with a 0.025 inch thickness, or 0.7 mm, or with a thickness in a range of 0.010-0.075 inches, and a weight of 320 gsm; or in a range of 270-370 gsm, wherein the extremely high molecular weight yields several unique properties including chemical inertness, lubricity, high abrasion resistance and impact strength;
b) a central penetration-resistant layer 512, which can be made from a relatively tough material, which is both relatively strong and relatively ductile, such as for example a nonwoven fabric made from 100% HPPE (High Performance Polyethylene), which can be configured with a 0.100″ thickness, or with a thickness in a range of 0.050-0.150 inches, and a weight of 220 gsm; or in a range of 170-270 gsm;
   wherein the outer cut-resistant layer 511 is substantially harder than the central penetration-resistant layer 512, such as for example at least 50% harder than the central penetration-resistant layer 512 (as measured by an appropriate hardness unit of measure, such as Shore durometer type A, B, C, D, E, M, 0, 00, D0, 0000, or 000-S, etc.); and
   wherein the central penetration-resistant layer 512 is substantially more ductile than the outer cut-resistant layer 511, such as for example at least 50% more ductile than the outer cut-resistant layer 511 (as measured by an appropriate ductility unit of measure, such as percent/relative elongation [engineering strain at fracture] or percent/relative reduction of area at fracture);
   wherein the central penetration-resistant layer 512 is thicker than the outer cut-resistant layer 511, such as for example at least 50% thicker than the outer cut-resistant layer 511; and
c) an inner soft layer 514, which can be made of a relatively soft material, which is softer than the cut-resistant material 113, such as for example a 100% Polyester fabric, which can be configured with a 0.020 inch thickness, or with a thickness in a range of 0.010-0.050 inches;
   wherein softness can be measured via a bending stiffness test, such as via the ASTM™ D1388 Standard Test Method for Stiffness of Fabrics; via compression testing, such as the KAWABATA™ Evaluation System, via a bending length test, or via an industry standard hand feel assessment on a scale from 1-10 conducted by a panel of trained experts, or via other well-known methods or systems for softness testing, including durometer measurement;
   wherein the inner soft layer 514 can protect the side mirror 182 from being scratched by the bag portion 112, particularly if the cut-resistant material 113 comprises a hard material such as a stainless steel fabric or chainmail. The inner soft layer 514 can for example be a soft fabric that is glued or sewed onto the inner side, or can be made from a rubber material, for example in the form of a rubber layer 514 or rubber coating 514 that is applied to, such as glued or fused onto, the inner side.

In a further related embodiment, the outer cut-resistant layer 511, can be a composite material, which can include:
a) Ultra-High Molecular Weight Polyethylene, in a proportion of 66% or 60-70% by weight;
b) Fiberglass, in a proportion of 21% or 15-25% by weight; and
c) Polyester, in a proportion of 21% or 15-25% by weight.

In further related embodiments, the outer cut-resistant layer 511, the central penetration-resistant layer 512, and the inner soft layer 514, can be permanently connected using well-known methods for connecting fabric or material sheet layers, such that the layers for example can be sewn, glued, and/or fused (i.e., by at least one or a combination of these methods).

In another further related embodiment, the outer cut-resistant layer 511 can be reinforced with poly-paraphenylene terephthalamide.

In yet a further related embodiment, as shown in FIG. 5B, the cut-resistant material 523, 113, can further include:
a) an intermediate layer 516, which is positioned between the outer cut-resistant layer 511 and the central penetration-resistant layer 512, wherein the intermediate layer 516 can be made from a hard strong material, such as perforated stainless steel, wherein the intermediate layer 516 can be configured as a mesh, such as a metal-alloy mesh, a stainless steel mesh or weave, or a KEVLAR™ reinforced composite weave or mesh, which can be configured with a 0.025 inch thickness, or with a thickness in a range of 0.010-0.1 inches.

In a related embodiment, as shown in FIG. 5C, the cut-resistant material 533, can be configured as a composite multi-layer material, wherein the cut-resistant material 533 can include:
a) an outer cut-resistant layer 511, which can be made from a relatively hard material, which is both relatively strong and relatively hard, such as for example: a woven fabric made from UHMWPE (Ultra-High Molecular Weight Polyethylene), which can be configured with a 0.025 inch thickness, or 0.7 mm, or with a thickness in a range of 0.010-0.075 inches, and a weight of 320 gsm; or in a range of 270-370 gsm, wherein the extremely high molecular weight yields several unique properties including chemical inertness, lubricity, high abrasion resistance and impact strength;
b) an intermediate layer 516, which is positioned between the outer cut-resistant layer 511 and the inner soft layer 514, wherein the intermediate layer 516 can be made from a hard strong material, such as perforated stainless steel, such as a stainless-steel mesh or weave, or KEVLAR™ reinforced composite weave or mesh, which can be configured with a 0.025 inch thickness, or with a thickness in a range of 0.010-0.1 inches; and
c) an inner soft layer 514, which can be positioned on an inner side of the intermediate layer, wherein the inner soft layer is softer than the outer cut-resistant layer, wherein the inner soft layer 514 can be made of a relatively soft material, which is softer than the cut-resistant material 113, such as for example a 100% Polyester fabric, which can be configured with a 0.020 inch thickness, or with a thickness in a range of 0.010-0.050 inches;
   wherein the inner soft layer 514 can protect the side mirror 182 from being scratched by the bag portion 112, particularly if the cut-resistant material 113 comprises a hard material such as a stainless steel fabric or chainmail. The inner soft layer 514 can for example be a soft fabric that is glued or sewed onto the inner side, or can be made from a rubber material, for example in the form of a rubber layer 514 or rubber coating 514 that is applied to, such as glued or fused onto, the inner side.

In various further related embodiments, the cut-resistant material 533, 523, 113, can further include additional layers and combinations of materials.

In a further related embodiment, the theft protector bag 100 can further include:
a) at least one metal hog ring 152, which can be connected to the outer cut-resistant layer 511;
such that the lock cable 136 protrudes through the at least one metal hog ring 152, such the lock cable is securely connected to the lock bag.

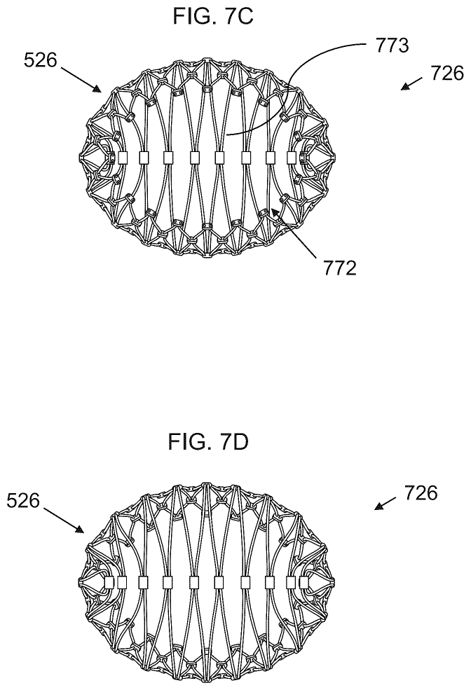

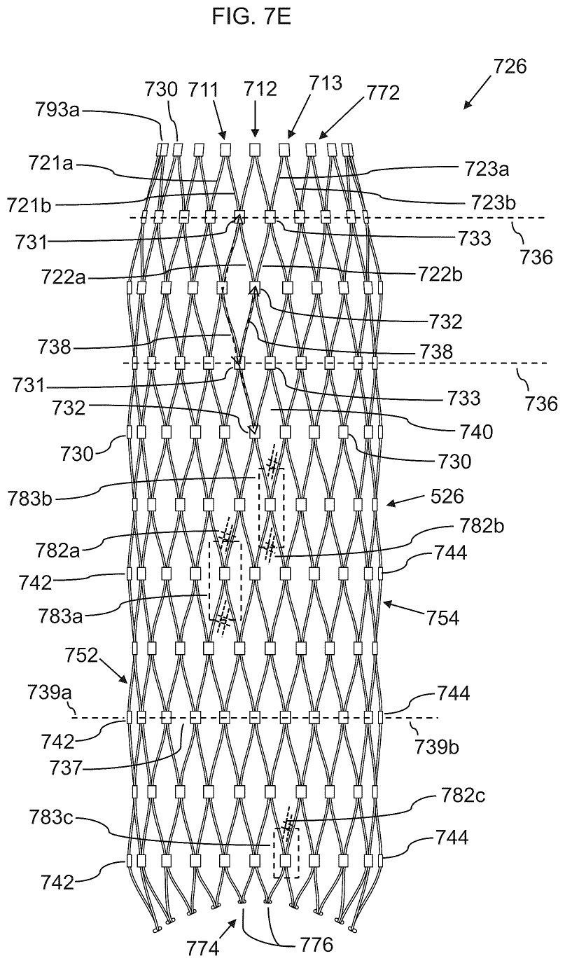

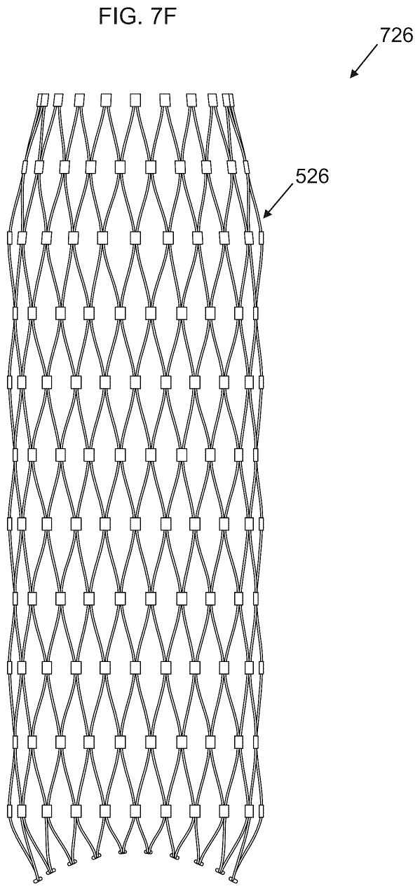

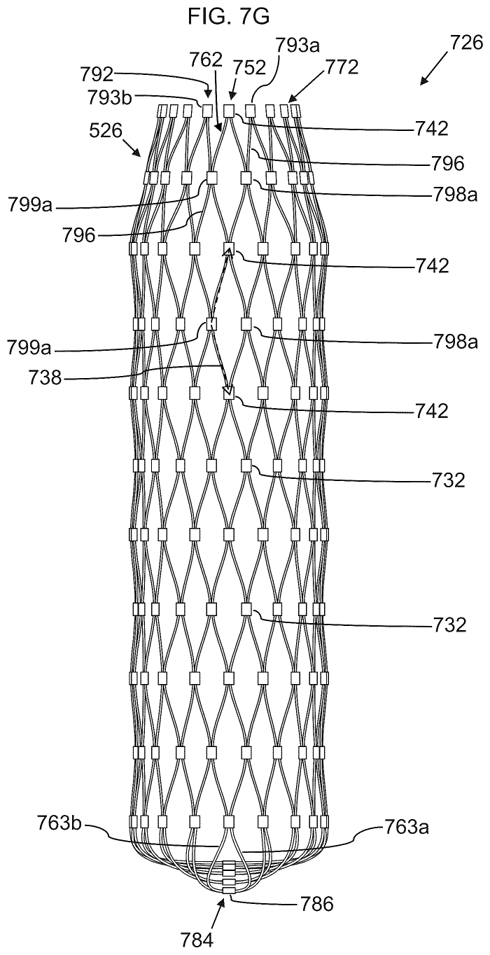

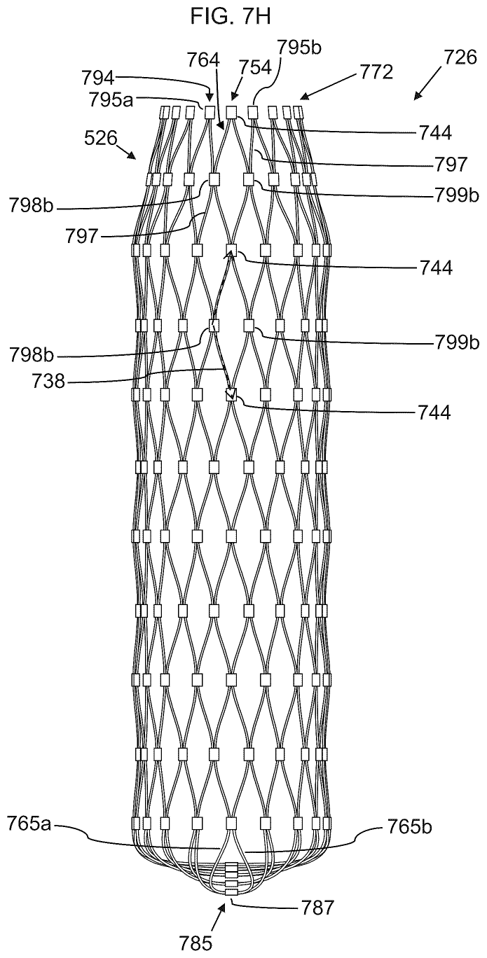

In a further related embodiment, as shown in FIGS. 5C-5D and 7A-7H, the cut-resistant material 533, 543 can be configured such that the intermediate layer 526 is configured as a diamond-shaped continuous wire mesh bag 726, wherein the intermediate layer 516 comprises:
a) a plurality of wire pair assemblies 711, 712, 713, each comprising:
   i. a first corresponding wire 721a, 722a, 723a, which can be a flexible wire; and
   ii. a second corresponding wire 721b, 722b, 723b, which can be a flexible wire; and
b) a plurality of wire connectors 730;
wherein for each wire pair assembly 711, 712, 713:
   i. a plurality of intermediate wire connectors 732 in the plurality of wire connectors 730 each connect the first corresponding wire 721a, 722a, 723a with the second corresponding wire 721b, 722b, 723b, such that the plurality of intermediate wire connectors 732 can be regularly spaced with a uniform wire distance 738 between longitudinally successive intermediate wire connectors 732, for each of the first corresponding wire 721a, 722a, 723a and the second corresponding wire 721b, 722b, 723b;
   ii. a plurality of preceding wire connectors 731 in the plurality of wire connectors 730 each connect a second preceding wire 721b of a preceding wire pair assembly 711 with the first corresponding wire 722a, such that the plurality of preceding wire connectors can be regularly spaced with the uniform wire distance 738 between longitudinally successive preceding wire connectors 731, such that each preceding wire connector 731 can be longitudinally positioned at a longitudinal midpoint 736 between the longitudinally successive intermediate wire connectors 732; and
   iii. a plurality of succeeding wire connectors 733 in the plurality of wire connectors 730 each connect the second corresponding wire 722b with a first succeeding wire 723a of a succeeding wire pair assembly 713, such that the plurality of succeeding wire connectors 733 can be regularly spaced with the uniform wire distance 738 between longitudinally successive succeeding wire connectors 733, such that each succeeding wire connector 733 can be longitudinally positioned at the longitudinal midpoint 736 between the longitudinally successive intermediate wire connectors 732;
such that a plurality of flexible substantially diamond-shaped openings 740 form between wires between pairs of longitudinally successive intermediate wire connectors 732 and connected pairs of a preceding wire connectors 731 and succeeding wire connectors 733;
wherein outer ends of the first corresponding wire 721a, 722a, 723a and the second corresponding wire 721b, 722b, 723b of each wire pair assembly 711, 712, 713 can be connected to form a loop 772, such that the plurality of wire pair assemblies 711, 712, 713 form a mesh bag opening 773 inside the loop 772, wherein each wire pair assembly 711, 712, 713 bends back 774 toward the loop 772 in mid-points 776 of the first corresponding wire 721a, 722a, 723a and the second corresponding wire 721b, 722b, 723b of the wire pair assembly 711, 712, 713, such that the intermediate layer 516 forms an elongated bag.

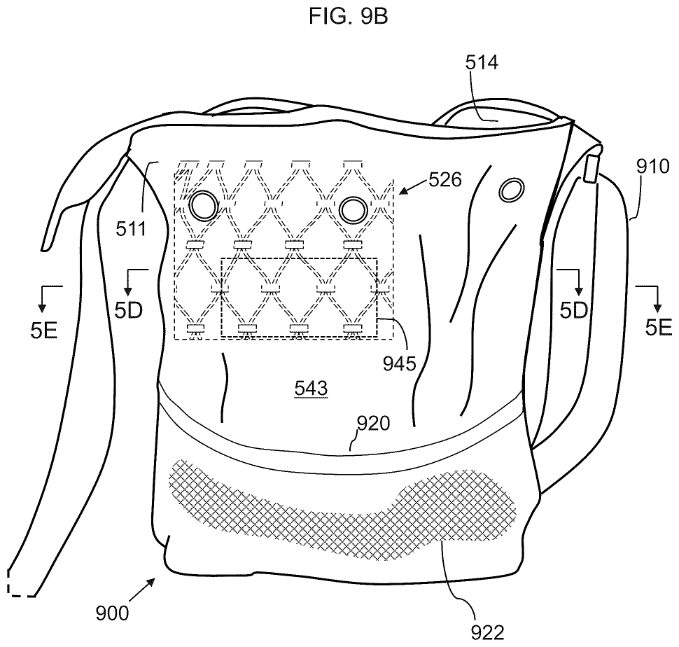

FIG. 5D shows a schematic cross-sectional view of a portion 945 of a cut-resistant material 543 with an intermediate layer 526 configured as a wire mesh, taken along section line 5D-5D of FIG. 9B, according to an embodiment of the invention.

FIG. 5E shows a schematic cross-sectional view of a portion 945 (as shown in FIG. 9B) of a cut-resistant material 543 with an intermediate layer 526 configured as a wire mesh, taken along section line 5E-5E of FIG. 9B, according to an embodiment of the invention.

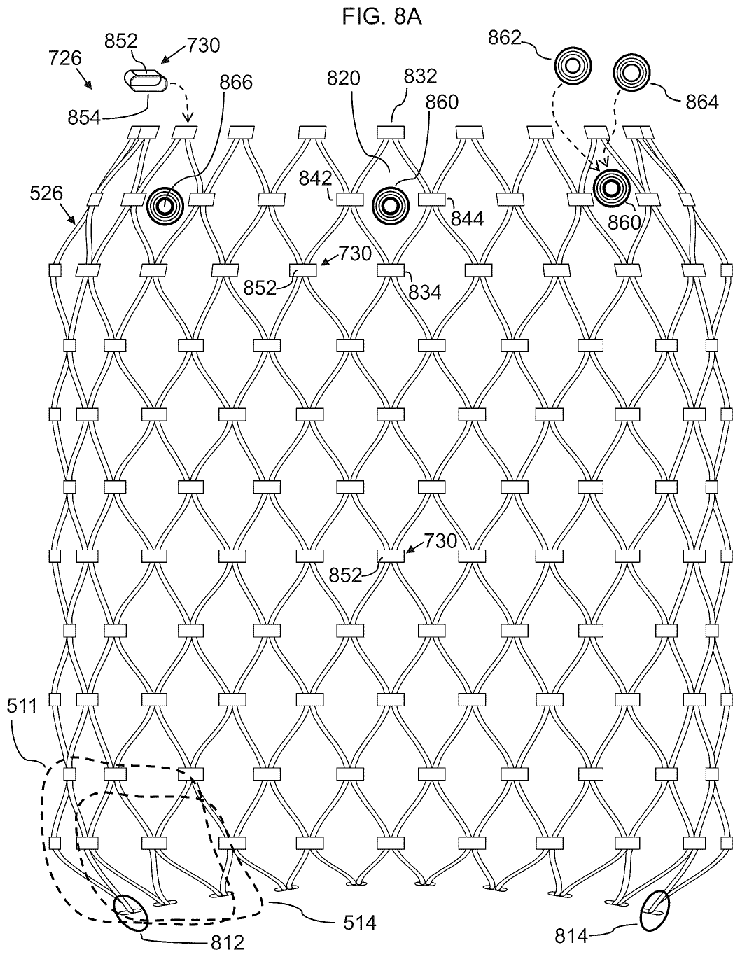

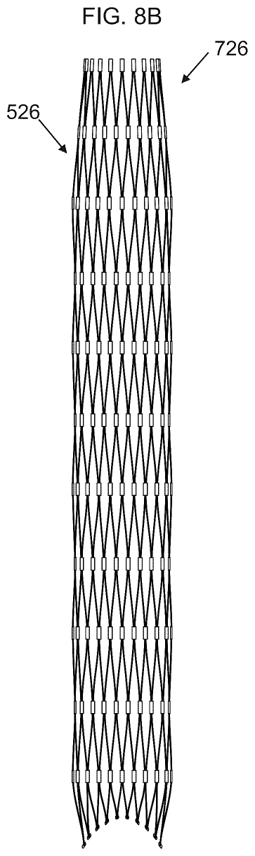

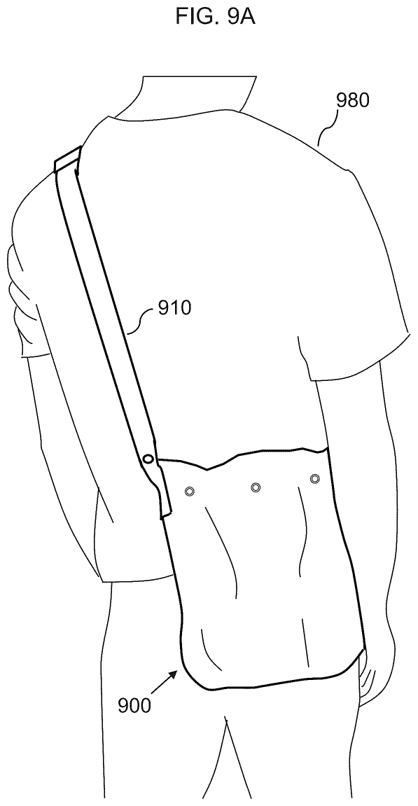

In related embodiments, the diamond-shaped continuous wire mesh bag 726 may be laterally flexible when constructed with flexible wires. FIG. 8A shows a side view of a continuous wire mesh bag 726 in a laterally expanded configuration. FIG. 8B shows a side view of a continuous wire mesh bag 726 in a laterally compressed configuration. This lateral flexibility may facilitate storage and aid in expansion to fit larger items. Note that FIGS. 8A and 8B are schematic views that include some distortion of the relative sizes of the wire connectors 730 and wires.

In another further related embodiment, as shown in FIGS. 5C-5D and 7A-7H, the intermediate layer 526 configured as a continuous wire mesh bag 726 can be configured such that:
a) a first end of the first wire 721a, 722a, 723a can be connected to a first end of the second wire 721b, 722b, 723b with a first outer/top connector 731, 732, 733, as shown in the top view of FIG. 7E; and
b) a second end of the first wire 721a, 722a, 723a can be connected to a second end of the second wire 721b, 722b, 723b with a second outer/bottom connector 731, 732, 733, as shown in the bottom view of FIG. 7E.

In a further related embodiment, as shown in FIGS. 7G and 7H, the intermediate layer 516 can further comprise:
a) a left outermost single-wire assembly 752 (as shown in FIG. 7G), which comprises:
   i. a left outermost wire 762, which bends back 784 toward the loop 772 in a left midpoint 786 of the left outermost wire 762, such that a plurality of intermediate outer left wire connectors 742 in the plurality of wire connectors 730 connects a left front section 763a of the left outermost wire 762 with a left rear section 763b of the left outermost wire 762, such that the plurality of intermediate outer left wire connectors 742 can be regularly spaced with the uniform wire distance 738 between successive intermediate outer left wire connectors 742, for each of the left front section 763a of the left outermost wire 762 and the left rear section 763b of the left outermost wire 762, such that each intermediate outer left wire connector 742 is longitudinally positioned at level 739a with a corresponding level 737 of intermediate wire connectors 732; and
b) a right outermost single-wire assembly 754 (as shown in FIG. 7H), which comprises:
   i. a right outermost wire 764, which bends back 785 in a right midpoint 787 of the right outermost wire 764, such that a plurality of intermediate outer right wire connectors 744 in the plurality of wire connectors 730 connects a right front section 765a of the right outermost wire 764 with a right rear section 765b of the right outermost wire 764, such that the plurality of intermediate outer right wire connectors 744 can be regularly spaced with a uniform wire distance 738 between successive intermediate outer right wire connectors 744, for each of the right front section 765a of the right outermost wire 764 and the right rear section 765b of the right outermost wire 764, such that each intermediate outer right wire connector 744 is longitudinally positioned at level 739b with the corresponding level 737 of intermediate wire connectors 732.

In a further related embodiment, as shown in FIGS. 7G and 7H, the intermediate layer 516 can be configured such that:
a) the left outermost single-wire assembly 752 (as shown in FIG. 7G) can be connected to a left outermost wire pair assembly 792 of the plurality of wire pair assemblies 711, 712, 713, which spans from a left front top end 793a to a left rear top end 793b;
   such that the left outermost wire 762 of the left outermost single-wire assembly 752 is connected to a left first corresponding wire 796 of the left outermost wire pair assembly 792, with a plurality of preceding front left outermost wire connectors 798a and preceding rear left outermost wire connectors 799a (from a left front top to a left rear top; note that the left first corresponding wire 796 is indicated both in a front section and a rear section of the left first corresponding wire 796); and
b) the right outermost single-wire assembly 754 (as shown in FIG. 7H) can be connected to a right outermost wire pair assembly 794, which spans from a right front top end 795a to a left rear top end 795b;
   such that the right outermost wire 764 of the right outermost single-wire assembly 754 is connected to a right first corresponding wire 797 of the right outermost wire pair assembly 794, with a plurality of preceding front right outermost wire connectors 798b and preceding rear right outermost wire connectors 799b (from a right front top to a right rear top; note that the right first corresponding wire 797 is indicated both in a front section and a rear section of the right first corresponding wire 797).

In a further related embodiment, each of the first corresponding wire 721a, 722a, 723a, the second corresponding wire 721b, 722b, 723b, and the left and right outermost wires 762, 764 can be made of a strong metal alloy, such as stainless steel, including CRES 316, such as the stainless-steel alloy 316L.

In various embodiments, each of the first corresponding wire 721a, 722a, 723a, the second corresponding wire 721b, 722b, 723b, and the left and right outermost wires 762, 764 can have a diameter in a range of 0.5-1.5 mm or more, and can be configured as:
a) a single-strand wire,
   which for example can be made from stainless steel, or another high-strength material, including aromatic polyamide fibers, such as Poly-paraphenylene terephthalamide, or poly(p-phenylene-2,6-benzobisoxazole)/PBO; or
b) a multi-strand wire/cable, which includes a plurality of single-strand wires twisted or braided together,
   wherein each single-strand wire can for example made from stainless steel, or another high-strength material, including aromatic polyamide fibers, such as Poly-paraphenylene terephthalamide, or poly(p-phenylene-2,6-benzobisoxazole)/PBO.

In a further related embodiment, each of the wire connectors 730 can be made of a high-strength material including a metal alloy, such as aluminum, including aluminum alloy 6063; and stainless steel, including corrosion-resistant steel 316 (CRES 316), such as the stainless-steel alloy 316L.

In another related embodiment, as shown in FIG. 8A, the wire connectors 730 can each be configured as an elongated hollow cylinder or tube, which can be crimped around two cables or cable portions; wherein the wire connectors 730 can each be configured as a rounded rectangular cylindrical tube, which can comprise flat/straight front and rear sides 852, 854 and semicircular ends, such that the wire connectors 730 can have a capsule-shaped, racetrack-shaped, or stadium-shaped cross-sectional shape.

In a further related embodiment, as shown in FIGS. 7E and 8A, the wire connectors 730 can each be configured as an elongated hollow tube, which can include:
a) a flat front side 852; and
b) a flat rear side 854;
such that the flat front side 852 and the flat rear side 854 of each corresponding wire connector 730 are substantially parallel with a local tangent plane 783a, 783b, 783c of a local wire spanning plane 782a, 782b, 782c, which is spanned out adjacent to the corresponding wire connector 730 by the first corresponding wire 721a, 722a, 723a and the second corresponding wire 721b, 722b, 723b. In general, front/rear (outer/inner) flat sides of all wire connectors 730 can be configured to be substantially parallel with a local tangent plane (relative to each wire connector 730) of an entire bag-shaped plane (i.e., a two-dimensional manifold that forms the shape of a three-dimensional bag) spanned out by the continuous wire mesh bag 726.

In a related embodiment, as shown in FIG. 8A, the cut-resistant material 533 can further include:
a) at least two stitches 812, 814, which are positioned on opposing sides of a bottom of the intermediate layer 516, 526;
such that each stitch 812, 814 of the at least two stitches 812, 814 encircles at least two adjoining wires of the wire mesh of the intermediate layer 516, and stitches through the outer cut-resistant layer 511 and the inner soft layer 514;
such that bottoms of the outer cut-resistant layer 511, the wire mesh of the intermediate layer 516, 526, and the inner soft layer 514 are held securely in position in a bottom of the bag portion of the lock bag.

In another related embodiment, each reinforced hole 114 can be positioned in an upper mesh opening 820 between an uppermost intermediate wire connector 832 and a successive intermediate wire connector 834, and between a preceding corresponding wire connector 842 and a succeeding corresponding wire connector 844.

In a further related embodiment, as shown in FIG. 8A each reinforced hole 114 can further include:
a) a male grommet member 862; and
b) a female grommet member 864;
such that the male grommet member 862 and the female grommet member 864 can be clamped together in the upper mesh opening 820 to form a connected grommet 860, such that the connected grommet 860 connects the outer cut-resistant layer 511 and the inner soft layer 514 with a central grommet opening 866 (with corresponding holes cut out in the outer cut-resistant layer 511 and the inner soft layer 514, respectively).

In other related embodiments, the cable lock assembly 130 can be any high strength cable lock assembly, for example made of high-strength steel, such as PYTHON™, keyed, or combination cable lock assemblies from MASTER LOCK™, or any other cable lock assembly from other manufacturers. The lock cable 136 can be permanently secured to the lock body 132 in a first end of the lock cable 136, such that a second end of the lock cable 136 is releasably lockable to the lock body 132. Alternatively, first and second ends of the lock cable 136 can include respectively first and second loops, such that the lock body 132 is a pad lock 132, such that the lock cable 136 is locked closed with the pad lock 132.

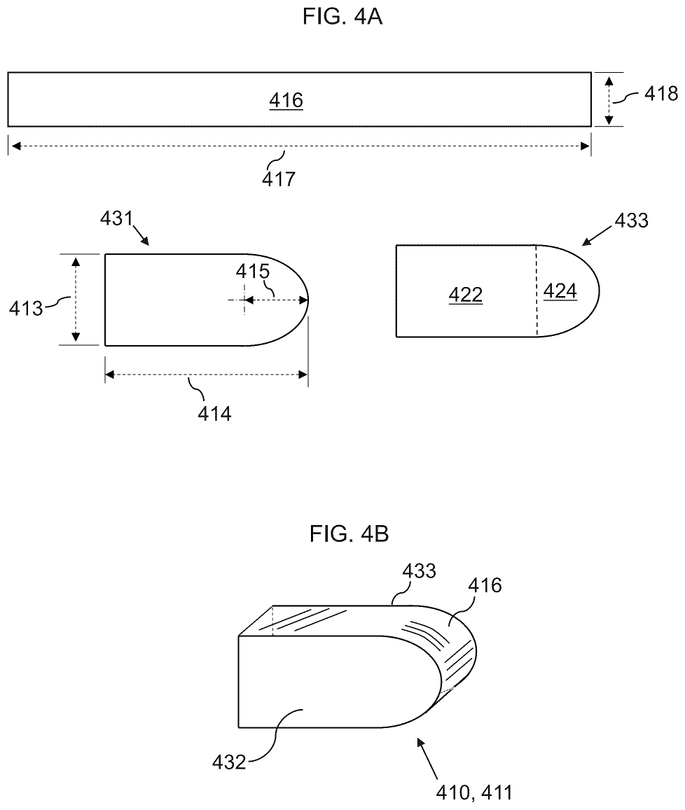

In a related embodiment, as shown in FIGS. 4A and 4B, bag-shaped layers (i.e. the outer bag 410, and the inner bag 411) of the bag portion 112 can each be manufactured from a center portion 416, which is connected (such as sewn, glued, or fused) between two side portions 432, 433. As shown, the center portion 416 can be an elongated rectangular piece, for example with a center length 417 of 38 inches and a width 418 of 5 inches. The first and second side portions 432, 433 can each include a front rectangular piece 422 connected with a rear curved section 424, which can be half circle, half ellipsoid, or half parabolic curve; for example, with a front length 414 of 18 inches and a height 413 of 9 inches of the front rectangular piece 422, and a center radius 415 of the rear curved section of 6 inches. Alternatively, the center portion 416 can have a center length 417 of 30-46 inches and a width 418 of 2-8 inches, and the first and second side portions 432, 433 each can have a front rectangular piece with a front length 414 of 12-24 inches and a height 413 of 6-12 inches, and a center radius 415 of the rear curved section of 3-9 inches.

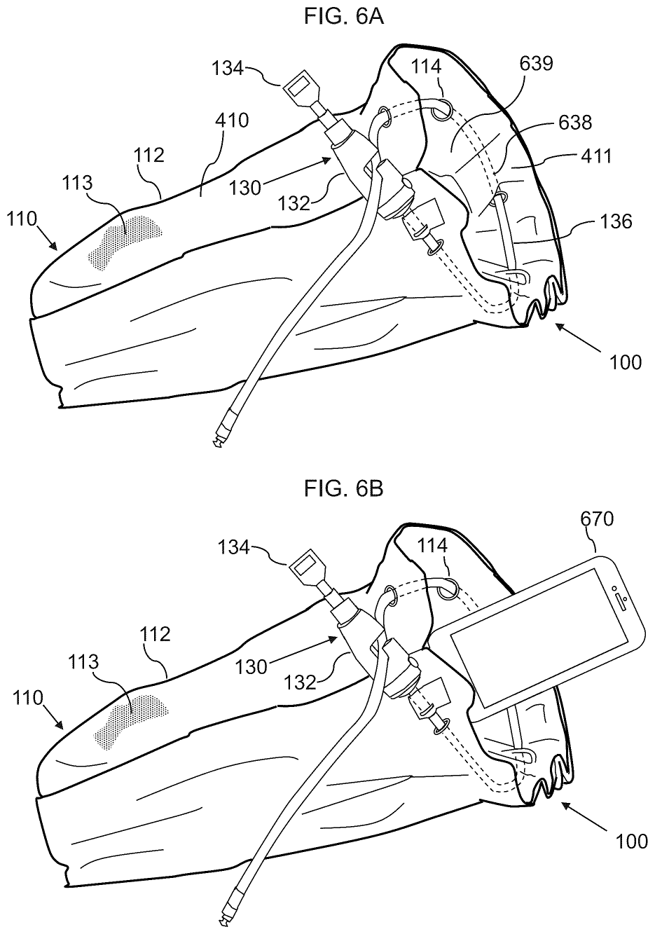

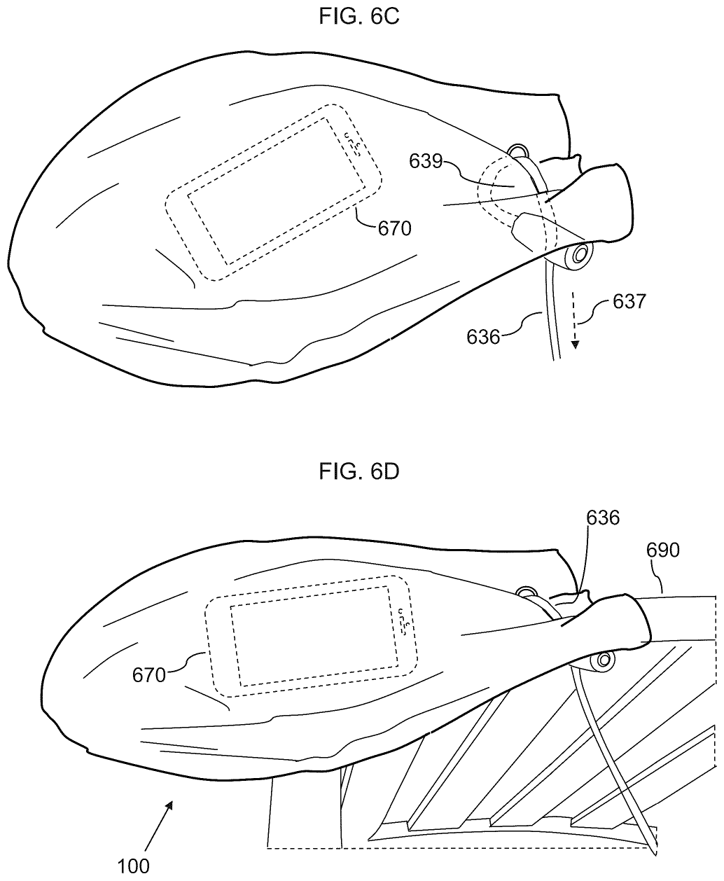

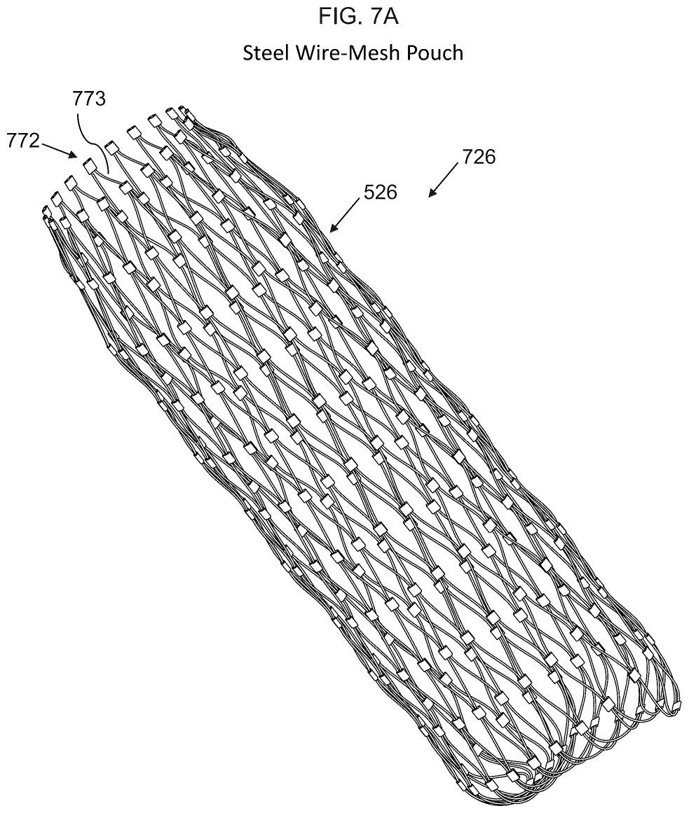

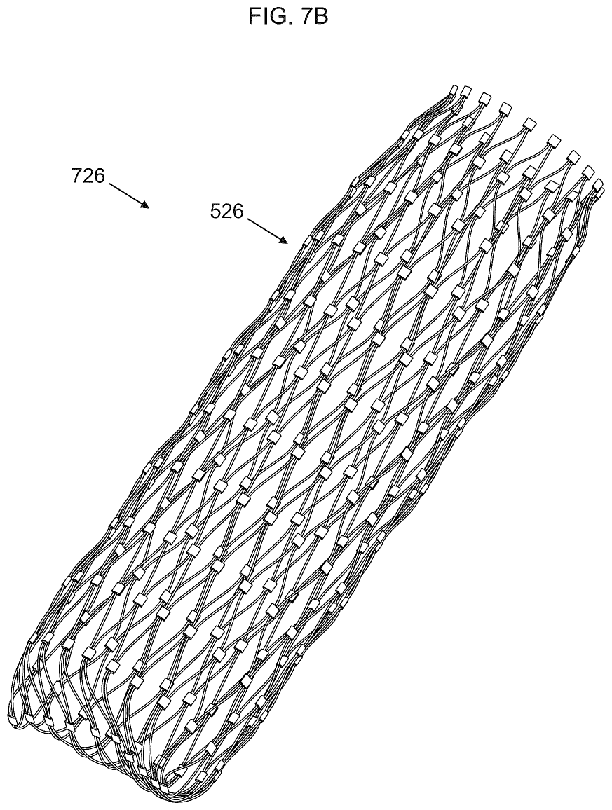

In a further related embodiment, as shown in FIGS. 4A and 4B, each of the outer cut-resistant layer 511 and the inner soft layer 514 can include:
a) a center portion 416;
b) a first side portion 432; and
c) a second side portion 433;
wherein the center portion 416 is connected between the first side portion 432 and the second side portion 433, to form an outer bag 410 or an inner bag 411, respectively, as shown in FIGS. 4B and 6A.

In another embodiment, as shown in FIGS. 6A, 6B, 6C, and 6D, a theft protector bag 100, can include:
a) a lock bag 110, which can include:
   i. a bag portion 112, which can be made from a cut-resistant material 113, wherein the bag portion 112 can be configured to contain an object 670; and
   ii. a cable guide 114, which can be mounted to an outer periphery of the bag portion along an opening to the interior of the bag portion, such that the cable guide can be:
      1. a continuous tube 114 (also called a hem 114 or casing 114; for example, formed by folding and sewing the outer ends of the material used for the bag portion); or
      2. a plurality of reinforced holes in the cut-resistant material 113 or guide segments, which allows a lock cable 136 of a cable lock assembly 130 to be laced through the plurality of holes or guide segments; and
b) a cable lock assembly 130, which can include:
   i. a lock body 132, which for example can be locked and unlocked with a key 134 or other locking mechanism;
   ii. a lock cable 136, which can be releasably lockable onto the lock body 132, such that the lock body 132 and lock cable 136 form a closed loop 638 with a loop opening 639, when the cable lock assembly 130 is locked; and
   iii. a key 134, which is configured to lock and unlock the lock body 132, to secure and release the lock cable 136;
wherein the lock cable 116 protrudes through the cable guide, such that the cable lock assembly 130 is attached to the lock bag 110;
whereby an object 670, such as a mobile device 670 or key, etc., can be positioned in an interior of the lock bag 110, when the theft protector bag 100 is unlocked, as shown in FIGS. 6A and 6B; and
whereby the theft protector bag 100 can be secured in position (i.e. is securable in position) with the lock cable 136 securely attached to a mounting structure 690, such as a pool chair 690, rail, or other structure, for example such that the lock cable 136 is wrapped around the mounting structure 690 or penetrates through the mounting structure 690, and with the lock bag 110 closed with the object 670 locked in the interior of the lock bag 110, thereby preventing theft of the object 670, when the theft protector bag 100 is closed tight and locked onto the mounting structure 690, as shown in FIGS. 6C and 6D. FIG. 6D shows that the lock cable 136 can be wrapped an extra turn around the mounting structure 690.

In a related embodiment, as shown in FIGS. 6A, 6B, 6C, and 6D, the cable lock assembly 130 can be configured such that the lock cable 136 protrudes through the lock body 132, such that the lock cable 136 can be tightened 637 and locked with a minimal loop opening 639, by pulling on an outer end of the lock cable 136, such that the object is locked inside the bag portion 112 and cannot be removed via the minimal loop opening 639.

Thus, in related embodiments, the theft protector bag 100 can be used to secure personal objects 670 at public places, such as at a public pool or at the beach, and the theft protector bag 100 can be used to prevent theft of a mirror portion 184 of a side mirror 182 of a vehicle 180.

Thus, in various related embodiments, features of the theft protector bag 100 can include:
a) A diamond-shaped continuous wire mesh bag/bag 726 with a diamond-pattern of diamond-shaped openings 740, with a closed top of diamond-shaped openings 740 at the mesh bag opening 773;
b) A lock cable 136 (of a cable lock assembly 130), which passes through grommets 860, each comprising male and female grommet members 862, 864. The lock cable 136 can for example be configured with a quarter-inch diameter;
c) Sewed stitches 812, 814 onto and between the outer bag 410 and the inner bag 411 of the theft protector bag 100;
d) A 1.5 inch vertical/longitudinal distance from an edge of the bag opening to a center of the grommets 860; and
e) A steel hog ring 152, which permanently secures the lock cable 136 to the outer bag 410 of the theft protector bag 100.

In various related embodiments, a manufacturing process for the diamond steel mesh security bag can include:
a) The theft protector bag 100 can be made from three layers, wherein:
   i. An outer cut-resistant layer 511 (the first layer), which can be Ultra High Molecular Weight Polyethylene (UHMWPE), which is a thick anti-slash fabric material sewed in 3 pieces;
   ii. An intermediate layer 516 (The mid-layer second layer), which can be a single piece made in a 360-degree construction without any welding and/or seams, constructed as a stainless-steel mesh made of corrosion resistant steel cables/wires 721a, 722a, 723a, 721b, 722b, 723b, 762, 764 (CRES wires/cables) (for example 30 or more wires/cables) held together with a grid of metal (steel or aluminum) wire connectors 730 (which can also be referred to as “stubbies”), which marry two cables/wires at a time by compression. The vertical distance between wire connectors 730 can be approximately 1.5 inches and about 1 inch horizontally when the mesh is in its relaxed position. This array of wire connectors 730 and steel cables/wires can thereby form a single 360 degrees closed-loop mesh that has no welding and/or seams. Also, this construction makes the CRES cable mesh extremely flexible which allows for compression and expansion of the final assembled bag 100, which is a unique quality of this bag 100, as shown in FIGS. 8A and 8B;
   iii. An inner soft layer 514 (the third layer), which can be a thick 100% polyester inner liner that protects the vehicle sideview mirrors chassis from scratches from the wire connectors 730 and wires/cables. This inner layer can be made of 3 pieces sewed together;
b) The process of assembling the theft protector bag 100 can include:
   i. Sewing the 3 pieces of outer UHMWPE fabric material, which form the outer bag 410 of the outer cut-resistant layer 511;
   ii. Sewing the 3 pieces of Polyester inner material, which form the inner bag 411 of the inner soft layer 514;
   iii. Reversing (inside-out) the outer bag 410 and inserting it inside the CRES cable/wire mesh bag 726 of the intermediate layer 516. The CRES cable/wire mesh bag 726 is symmetrical and does not require reversing because it does not have any seams or weldments;
   iv. Reversing (inside-out) the inner bag 411 and stitching, at the bottom, with 2 strong stitches 812, 814 (this stitching operation is done by hand), the outer and the inner bags; looping the stiches around 2 of the cables/wires of the CRES cable/wire mesh bag on opposite sides of a bottom of the theft protector bag 100 (this stitching operation is done in 2 opposite places at the bottom of the bags). This operation ensures that the outer bag 410, the inner bag 411, and the cable/wire mesh bag 726 are connected tight together at a bottom of the theft protector bag 100, preventing the inner bag 411 from coming out of position each time the theft protector bag 100 is removed from the vehicle sideview mirrors;
   v. Reversing the outer bag 410, the CRES cable/wire mesh bag 726 and the inner bag 411 (as an assembly) to their original position to perform the top sewing operation of between the outer bag 410 and the inner bag 411 only at the very top opening of the theft protector bag 100;
   vi. Sewing the outer bag 410 and the inner bag 411 together all around the top of the bags (only the inner and outer bags are sewed together).
      The CRES mesh bag 726 can be about ½ inch shorter than both the outer bag 410 and the inner bag 411 to allow for a sewing machine to sew both the outer bag 410 and the inner bag 411 together at the very top only;
   vii. A series of holes (typically a minimum of 6 holes) is then placed 1.5 inches from the top of the fabric bags penetrating both fabric bags in order to place the necessary metal (such as nickel-plated brass or steel) grommets 860 that will serve 2 functions:
      1) Securing the CRES cable/wire mesh bag 726 at the very top by ensuring each grommet 860 (of male and female grommet members 862, 864) are passing through the holes, the diamond-shaped openings at the top of the CRES mesh bag 726, such that the male and female grommet members 862, 864 are compressed together to lock the intermediate layer 516 of the CRES mesh bag 726 in place. This can be done manually for each Grommet 860 required; and
      2) The Grommets 860 also serve as the passing reinforced holes 114 for the lock cable 136 that securely close the secures the bag to the vehicle sideview mirror; and
c) The final step is to pass the lock cable 136 through each of the grommets 860 and securing one end of the cable to the outer bag with a stainless-steel hog ring 152, to ensure only one end of the lock cable 136 can move for proper installation of the theft protector bag 100 onto a vehicle side mirror 182 or other mounting structure 690.

In related embodiments, as shown in FIGS. 9A and 9B, the theft protector bag 100, 900 can be configured as a unisex purse or unisex bag 900 with the same general structure as the vehicle sideview mirror protector bag, for use by a user 980 to securely carry personal items, wherein the unisex purse/bag 900:
a) can further include a zipper on top to protect personal items from falling out of the unisex purse/bag 900;
b) can Internally be configured with two pockets (one with a zipper that holds the combination cable lock assembly and one without zipper;
c) can be configured such that on an outer side of the unisex bag 900, there can be an external pocket 920 to hold a water bottle or any item that might need quick accessibility. The external pocket 920 in some embodiments can be configured to include a mesh fabric material 922;
d) can further include a shoulder strap 910, which can be connected to the lock bag 110, such that the unisex theft protector bag 100 can be configured as a personal carry-bag for carry of personal items, to allow for easy cross-body carry; and
e) can be configured such that cable lock assembly 130 can be loose rather than permanently attached to the outer bag (as is typically the configuration for the vehicle side-mirror protector bag) because it allows the user 980 to use the cable lock assembly to secure the bag to any fixed structure while at the beach, the park, a concert, on the vehicle or while walking within crowds to prevent anybody from stealing their personal items;
wherein the unisex theft protector bag 900 is shown in FIGS. 9A and 9B in open unsecured configurations, without the cable lock assembly 130 attached and tightened;
wherein FIG. 9B shows an internal portion of the intermediate layer 526 configured as a wire mesh bag 726 (shown in dotted lines as normally hidden between the outer cut-resistant layer 511 and the inner soft layer 514).

Here has thus been described a multitude of embodiments of the theft protector bag 100, and methods related thereto, which can be employed in numerous modes of usage.

The many features and advantages of the invention are apparent from the detailed specification, and thus, it is intended by the appended claims to cover all such features and advantages of the invention, which fall within the true spirit and scope of the invention.

Many such alternative configurations are readily apparent and should be considered fully included in this specification and the claims appended hereto. Accordingly, since numerous modifications and variations will readily occur to those skilled in the art, the invention is not limited to the exact construction and operation illustrated and described, and thus, all suitable modifications and equivalents may be resorted to, falling within the scope of the invention.

What is claimed is:

1. A theft protector bag, comprising:
a) a lock bag, which is made from a cut-resistant material, wherein the lock bag comprises:
a bag portion, which is configured to be put over a side mirror of a vehicle; and
a cable guide, which is mounted to an outer periphery of the bag portion, along a bag opening to an interior of the bag portion; and
b) a cable lock assembly, which comprises:
a lock body; and
a lock cable, which is releasably lockable to the lock body, such that the lock cable forms a closed loop with a loop opening, when the cable lock assembly is locked;
wherein the lock cable protrudes through the cable guide, such that the cable lock assembly is attached to the lock bag;
whereby the lock bag is positionable over the side mirror with the side mirror inside the interior of the bag portion, when the theft protector bag is unlocked; and
whereby the theft protector bag is secured in position on the side mirror, thereby preventing theft of a mirror portion of the side mirror, when the theft protector bag is locked onto the side mirror.

2. The theft protector bag of claim 1, wherein the cut-resistant material comprises:
a) an outer cut-resistant layer; and
b) an intermediate layer, which is positioned on an inner side of the outer cut-resistant layer, wherein the intermediate layer is configured as a mesh.

3. The theft protector bag of claim 2, wherein the outer cut-resistant layer is a woven fabric made from ultra-high molecular weight polyethylene; and wherein the mesh is a stainless-steel mesh.

4. The theft protector bag of claim 2, further comprising:
at least one metal hog ring, which is connected to the outer cut-resistant layer;
such that the lock cable protrudes through the at least one metal hog ring, such the lock cable is securely connected to the lock bag.

5. The theft protector bag of claim 2, wherein the mesh is configured as a wire mesh, such that the intermediate layer comprises:
a plurality of wire pair assemblies, each comprising:
a first corresponding wire; and
a second corresponding wire;
wherein outer ends of the first corresponding wire and the second corresponding wire of each wire pair assembly are connected to form a loop, such that the plurality of wire pair assemblies form a mesh bag opening inside the loop, wherein each wire pair assembly bends back toward the loop in mid-points of the first corresponding wire and the second corresponding wire of the wire pair assembly, such that the intermediate layer forms a bag.

6. The theft protector bag of claim 5, wherein the intermediate layer further comprises:
a plurality of wire connectors;
wherein for each wire pair assembly:
a plurality of intermediate wire connectors in the plurality of wire connectors each connect the first corresponding wire with the second corresponding wire;
wherein a plurality of preceding wire connectors in the plurality of wire connectors each connect a second preceding wire of a preceding wire pair assembly with the first corresponding wire; and
wherein a plurality of succeeding wire connectors in the plurality of wire connectors each connect the second corresponding wire with a first succeeding wire of a succeeding wire pair assembly.

7. The theft protector bag of claim 6, wherein each wire connector in the plurality of wire connectors is configured as an elongated hollow tube, which comprises:
a flat front side;
such that the flat front side of each wire connector in the plurality of wire connectors is substantially parallel with a local tangent plane of a local wire spanning plane, which is spanned out adjacent to each wire connector by the first corresponding wire and the second corresponding wire.

8. The theft protector bag of claim 6, wherein the intermediate layer further comprises:
a) a left outermost single-wire assembly, which comprises:
a left outermost wire, which bends back in a left midpoint of the left outermost wire, such that a plurality of intermediate outer left wire connectors in the plurality of wire connectors connects a left front section of the left outermost wire with a left rear section of the left outermost wire, for each of the left front section of the left outermost wire and the left rear section of the left outermost wire; and
b) a right outermost single-wire assembly, which comprises:
a right outermost wire, which bends back in a right midpoint of the right outermost wire, such that a plurality of intermediate outer right wire connectors in the plurality of wire connectors connects a right front section of the right outermost wire with a right rear section of the right outermost wire, for each of the right front section of the right outermost wire and the right rear section of the right outermost wire.

9. The theft protector bag of claim 8, wherein:
a) the left outermost single-wire assembly is connected to a left outermost wire pair assembly of the plurality of wire pair assemblies;
such that the left outermost wire of the left outermost single-wire assembly is connected to a left first corresponding wire of the left outermost wire pair assembly, with a plurality of preceding front left outermost wire connectors and preceding rear left outermost wire connectors; and
b) the right outermost single-wire assembly is connected to a right outermost wire pair assembly;
such that the right outermost wire of the right outermost single-wire assembly is connected to a right first corresponding wire of the right outermost wire pair assembly, with a plurality of preceding front right outermost wire connectors and preceding rear right outermost wire connectors.

10. The theft protector bag of claim 8,
wherein the intermediate wire connectors are regularly spaced with a uniform wire distance between longitudinally successive intermediate wire connectors, for each of the first corresponding wire and the second corresponding wire;
wherein preceding wire connectors are regularly spaced with the uniform wire distance between longitudinally successive preceding wire connectors, such that each preceding wire connector is longitudinally positioned at a longitudinal midpoint between the longitudinally successive intermediate wire connectors;
wherein the succeeding wire connectors are regularly spaced with the uniform wire distance between longitudinally successive succeeding wire connectors, such that each succeeding wire connector is longitudinally positioned at the longitudinal midpoint between the longitudinally successive intermediate wire connectors;
wherein the plurality of intermediate outer left wire connectors are regularly spaced with the uniform wire distance between successive intermediate outer left wire connectors, such that each intermediate outer left wire connector is longitudinally positioned at level with a corresponding level of intermediate wire connectors; and
wherein the plurality of intermediate outer right wire connectors are regularly spaced with the uniform wire distance between successive intermediate outer right wire connectors, such that each intermediate outer right wire connector is longitudinally positioned at level with the corresponding level of intermediate wire connectors.

11. The theft protector bag of claim 6, wherein the cut-resistant material further comprises:
an inner soft layer, which is positioned on an inner side of the intermediate layer, wherein the inner soft layer is softer than the outer cut-resistant layer.

12. The theft protector bag of claim 11, wherein the cut-resistant material further comprises:
at least two stitches, which are positioned on opposing sides of a bottom of the intermediate layer;
such that each stitch of the at least two stitches encircles at least two adjoining wires of the wire mesh of the intermediate layer, and stitches through the outer cut-resistant layer and the inner soft layer;
such that bottoms of the outer cut-resistant layer, the wire mesh of the intermediate layer, and the inner soft layer are held securely in position in a bottom of the bag portion of the lock bag.

13. The theft protector bag of claim 11, wherein the cable guide comprises:
a plurality of reinforced holes in the cut-resistant material, which allows the lock cable to be laced through the plurality of reinforced holes;
wherein each reinforced hole is positioned in an upper mesh opening between an uppermost intermediate wire connector and a successive intermediate wire connector, and between a preceding corresponding wire connector and a succeeding corresponding wire connector.

14. The theft protector bag of claim 13, wherein each reinforced hole further comprises:
a) a male grommet member; and
b) a female grommet member;
such that the male grommet member and the female grommet member are clamped together in the upper mesh opening to form a connected grommet, such that the connected grommet connects the outer cut-resistant layer and the inner soft layer with a central grommet opening.

15. The theft protector bag of claim 11, wherein each of the outer cut-resistant layer and the inner soft layer comprises:
a) a center portion;
b) a first side portion; and
c) a second side portion;
wherein the center portion is connected between the first and second side portions.

16. The theft protector bag of claim 15, wherein the center portion is an elongated rectangular piece and the first and second side portions each include a front rectangular piece and a rear curved section, such that the rear curved section is connected to a rear of the front rectangular piece.

17. The theft protector bag of claim 16, wherein the center portion has a center length in a range of 30-46 inches and a width in a range of 2-8 inches, and the front rectangular piece has a front length in a range of 12-24 inches and a height in a range of 6-12 inches, and the rear curved section has a center radius in a range of 3-9 inches.

18. A theft protector bag, comprising:
a) a lock bag, which is made from a cut-resistant material, wherein the lock bag comprises:
a bag portion, which is configured to contain an object; and
b) a cable lock assembly, which comprises:
a lock body; and
a lock cable, which is releasably lockable to the lock body, such that the lock cable forms a closed loop with a loop opening, when the cable lock assembly is locked;
wherein the lock cable is attached to an outer periphery of the bag portion, along a bag opening to an interior of the bag portion;
such that the object is positionable in the interior of the bag portion, when the theft protector bag is unlocked.

19. The theft protector bag of claim 18, wherein the cut-resistant material comprises:
a) an outer cut-resistant layer; and
b) an intermediate layer, which is positioned on an inner side of the outer cut-resistant layer, wherein the intermediate layer is configured as a mesh.

20. The theft protector bag of claim 19, wherein the mesh is configured as a wire mesh, such that the intermediate layer comprises:
a plurality of wire pair assemblies, each comprising:
a first corresponding wire; and
a second corresponding wire;
wherein outer ends of the first corresponding wire and the second corresponding wire of each wire pair assembly are connected to form a loop, such that the plurality of wire pair assemblies form a mesh bag opening inside the loop, wherein each wire pair assembly bends back toward the loop in mid-points of the first corresponding wire and the second corresponding wire of the wire pair assembly, such that the intermediate layer forms a bag.

21. The theft protector bag of claim 20, wherein the intermediate layer further comprises:
a plurality of wire connectors;
wherein for each wire pair assembly:
a plurality of intermediate wire connectors in the plurality of wire connectors each connect the first corresponding wire with the second corresponding wire;
wherein a plurality of preceding wire connectors in the plurality of wire connectors each connect a second preceding wire of a preceding wire pair assembly with the first corresponding wire; and
wherein a plurality of succeeding wire connectors in the plurality of wire connectors each connect the second corresponding wire with a first succeeding wire of a succeeding wire pair assembly.

22. The theft protector bag of claim 21, wherein each wire connector in the plurality of wire connectors is configured as an elongated hollow tube, which comprises:
a flat front side;
such that the flat front side of each wire connector in the plurality of wire connectors is substantially parallel with a local tangent plane of a local wire spanning plane, which is spanned out adjacent to each wire connector by the first corresponding wire and the second corresponding wire.

23. The theft protector bag of claim 21, wherein the intermediate layer further comprises:
a) a left outermost single-wire assembly, which comprises:
a left outermost wire, which bends back in a left midpoint of the left outermost wire, such that a plurality of intermediate outer left wire connectors in the plurality of wire connectors connects a left front section of the left outermost wire with a left rear section of the left outermost wire, for each of the left front section of the left outermost wire and the left rear section of the left outermost wire; and
b) a right outermost single-wire assembly, which comprises:
a right outermost wire, which bends back in a right midpoint of the right outermost wire, such that a plurality of intermediate outer right wire connectors in the plurality of wire connectors connects a right front section of the right outermost wire with a right rear section of the right outermost wire, for each of the right front section of the right outermost wire and the right rear section of the right outermost wire.

24. The theft protector bag of claim 23, wherein:
a) the left outermost single-wire assembly is connected to a left outermost wire pair assembly of the plurality of wire pair assemblies;
such that the left outermost wire of the left outermost single-wire assembly is connected to a left first corresponding wire of the left outermost wire pair assembly, with a plurality of preceding front left outermost wire connectors and preceding rear left outermost wire connectors; and
b) the right outermost single-wire assembly is connected to a right outermost wire pair assembly;
such that the right outermost wire of the right outermost single-wire assembly is connected to a right first corresponding wire of the right outermost wire pair assembly, with a plurality of preceding front right outermost wire connectors and preceding rear right outermost wire connectors.

25. The theft protector bag of claim 23,
wherein the intermediate wire connectors are regularly spaced with a uniform wire distance between longitudinally successive intermediate wire connectors, for each of the first corresponding wire and the second corresponding wire;
wherein preceding wire connectors are regularly spaced with the uniform wire distance between longitudinally successive preceding wire connectors, such that each preceding wire connector is longitudinally positioned at a longitudinal midpoint between the longitudinally successive intermediate wire connectors;
wherein the succeeding wire connectors are regularly spaced with the uniform wire distance between longitudinally successive succeeding wire connectors, such that each succeeding wire connector is longitudinally positioned at the longitudinal midpoint between the longitudinally successive intermediate wire connectors;
wherein the plurality of intermediate outer left wire connectors are regularly spaced with the uniform wire distance between successive intermediate outer left wire connectors, such that each intermediate outer left wire connector is longitudinally positioned at level with a corresponding level of intermediate wire connectors; and
wherein the plurality of intermediate outer right wire connectors are regularly spaced with the uniform wire distance between successive intermediate outer right wire connectors, such that each intermediate outer right wire connector is longitudinally positioned at level with the corresponding level of intermediate wire connectors.

26. The theft protector bag of claim 23, wherein the cut-resistant material further comprises:
an inner soft layer, which is positioned on an inner side of the intermediate layer, wherein the inner soft layer is softer than the outer cut-resistant layer.

27. The theft protector bag of claim 26, wherein the cut-resistant material further comprises:
at least two stitches, which are positioned at a bottom of the intermediate layer;
such that each stitch of the at least two stitches encircles at least two adjoining wires of the wire mesh of the intermediate layer, and stitches through the outer cut-resistant layer and the inner soft layer;
such that bottoms of the outer cut-resistant layer, the wire mesh of the intermediate layer, and the inner soft layer are held securely in position in a bottom of the bag portion of the lock bag.

28. The theft protector bag of claim 26, wherein the lock bag further comprises:
a cable guide, which is mounted to an outer periphery of the bag portion, along a bag opening to an interior of the bag portion, wherein the cable guide comprises:
a plurality of reinforced holes in the cut-resistant material, which allows the lock cable to be laced through the plurality of reinforced holes;
wherein each reinforced hole is positioned in an upper mesh opening between an uppermost intermediate wire connector and a successive intermediate wire connector, and between a preceding corresponding wire connector and a succeeding corresponding wire connector.

29. The theft protector bag of claim 28, wherein each reinforced hole further comprises:
a) a male grommet member; and
b) a female grommet member;
such that the male grommet member and the female grommet member are clamped together in the upper mesh opening to form a connected grommet, such that the connected grommet connects the outer cut-resistant layer and the inner soft layer with a central grommet opening.

30. The theft protector bag of claim 20, further comprising:
a shoulder strap, which is connected to the lock bag;
such that the theft protector bag is configured as a personal carry-bag for carry of personal items.
